(19) United States
(12) Patent Application Publication
(10) Pub. No.: US 2012/0092297 A1
(43) Pub. Date: Apr. 19, 2012

(54) MULTI-TOUCH PANEL CAPACITANCE SENSING CIRCUIT

(76) Inventor: Sang Hyun HAN, Anyang-si (KR)

(21) Appl. No.: 13/275,567

(22) Filed: Oct. 18, 2011

(30) Foreign Application Priority Data
Oct. 18, 2010 (KR) 10-2010-0101544

(51) Int. Cl. G06F 3/044

(52) U.S. Cl. 345/174; 178/18.06

(57) ABSTRACT

Disclosed herein is a multi-touch panel capacitance sensing circuit. The multi-touch panel capacitance sensing circuit includes a touch panel, a transmission circuit unit, and a reception circuit unit. The touch panel includes transmission electrodes and reception electrodes. The transmission circuit unit applies a transmission signal, having a predetermined period, to the transmission electrodes in a time division manner. The reception circuit unit for detecting a difference in capacitance components, generated between the transmission electrode and the reception electrode, based on the reception electrode when a touch is generated by the human body of a user. The reception circuit unit includes a current mirror-based charge integration circuit, and detects whether a touch is generated or not.

### BACKGROUND OF THE INVENTION

1. Field of the Invention

The present invention relates generally to a multi-touch panel capacitance sensing circuit, and, more particularly, to a capacitance sensing circuit which is robust to noise flowing in from the outside, which has a high sensing speed, and which can be easily manufactured.

2. Description of the Related Art

With the development of electronics and information technology, the importance of electronic equipment, which occupies a large part of everyday life including the business environment, has constantly increased. Recently, the types of electronic equipment have become diversified. In particularly, newly designed equipment to which new functions are applied pours out every day in the field of mobile electronic equipment, such as notebooks, mobile phones, Portable Multimedia Players (PMPs), and tablet Personal Computers (PCs),

As the various types of electronic equipment are used in daily life and the functions of such electronic equipment becomes advanced and complicated, the necessity of a user interface which can be easily learned and intuitively manipulated by a user has arisen. Touch panel devices have received attention as input devices which can fulfill this need, and have already been applied to various types of electronic equipment.

In particularly, a touch screen device, which is the most general application of such a touch panel device, is referred to as a device which detects the position of touch generated by a user on a display screen, and performs general control on electronic equipment as well as the control of a display screen using information about the sensed touch position as input information. Further, with the popularization of such a touch screen device, when a touch screen is manipulated, the importance of a touch screen capacitance measurement circuit and a capacitance controller semiconductor which is in charge of the circuit has increased.

FIG. 1 is a view illustrating the touch sensing circuit of a conventional touch screen device.

As shown in FIG. 1, a touch screen device is configured such that a plurality of detection patterns 100, which are separated by predetermined intervals and coated with transparent metal oxides, are allocated in horizontal axes and vertical axes which are perpendicular to the respective horizontal axes. When a user comes into contact with the specific position of the touch screen, the touch position (Xn, Yn) of a contact point can be detected by sensing a variation in capacitance obtained from each of the detection patterns, by using the capacitance 114 sensed by the relevant detection pattern of the horizontal axis and the capacitance 124 sensed by the relevant detection pattern of the vertical axis.

Ordinarily, this method is capable of sensing the occurrence and non-occurrence of a touch by independently applying a detection signal to each of the detection patterns, and at the same time, measuring variation 110 and 120 in the detection signal, which is changed due to the touch generated by a user, by using the same signal line, so that this method is called a self cap method in the art.

However, a touch screen device using the self cap method is configured such that a single touch-based touch is easily sensed as shown in FIG. 1. When a user comes into contact with a point A(X2,Y2) and a point B(X5,Y5) using two fingers, the positions of the contact points, that is, the positions of the X and Y axes of sensing electrodes of the respective contact points, are detected using the sensed values 131, 132, 141, and 142 of the one-dimensional array of each of the X and Y axes. Therefore, it is determined that a user comes into contact with virtual contact points A′(X5,Y2) and B′(X2,Y5) as well as with actual contact points. Therefore, there is the basic problem of two or more points of multi-touch cannot be able to be accurately sensed.

FIG. 2 shows another prior art. In order to solve the problem of the first prior art, a touch panel technology using a multi-touch sensing method according to the second prior art shown in FIG. 2 has been used recently.

A touch panel including a multi-point sensing function according to the second prior art has a physical structure that has sensing electrodes, configured to sense the touch of a user and arranged to be perpendicular to each other, like the first prior art. However, the method of sensing the capacitance and the configurations of sensing circuits 210 and 220 of the touch panel according to the second prior art are different from those of the first prior art, as follows.

The method of measuring capacitance is configured such that a reference signal 211, having a square-wave type waveform and a predetermined period, is amplified 212 and switched 213 and then applied to each electrode line (transmission electrode) 202 which is formed in the horizontal direction of the touch panel 200 in a time-division manner, and that variation in a reception signal 226, transferred to each of the electrode lines (reception electrodes) 201 formed in the vertical axes, is detected based on a reference signal 214 applied to the horizontal direction for each period.

Therefore, while the first prior art has been known as the self cap method wherein capacitance is independently sensed using sensing electrodes of the vertical and horizontal axes, the method according to the second prior art is called a mutual cap in the art because it uses the method of only applying a specific signal 214 in the horizontal axis and only sensing capacitance components attributable to the signal 226 transferred from the horizontal axis in the vertical axis.

Description will be made with reference to FIG. 3 in which the principle of FIG. 2 is illustrated in more detail. When the transmission electrode 202 and the reception electrode 201 which are perpendicular to each other are insulated, the capacitance of a capacitor C0 309 between the transmission electrode 202 and the reception electrode 201 is formed due to insulating materials of an overlapping area, and, at the same time, the specific energy of the transmission electrode is transferred to the reception electrode by an electrostatic energy field generated based on the transmission signal 214 of the transmission electrodes. Here, when touch is generated by a user, the transmission signal 214, applied to each of the electrode lines 200 of the touch generation positions A and B, and the reception signal 226, transferred to the reception electrodes, have variations in capacitance and the electrostatic energy field formed on each of the electrodes due to the touch, thereby varying the amount of energy transferred to the reception electrode.

Here, the capacitance sensing circuit determines whether a touch is generated by a user by converting the electrical energy, that is, the charge (or the variation in capacitance) detected from the reception electrode, into units of voltage, and by using the difference in voltage when a touch is generated and voltage when a touch is not generated. The difference in charge attributable to the variation in capacitance is processed by measuring the variation in all the horizontal axes with respect to vertical axes which are independent from each other and configuring a two-dimensional array of a vertical axis and a horizontal axis using the measured values, thereby easily determining a multi-touch.

Since the width of the variation in the reception signal (charge), detected when a touch is generated by a human body, is generally a very small value (dozens of fF to several pF), a reception unit 220 uses a charge integrator circuit 222 for accumulating charge obtained from the reception signal 226, amplifying the accumulated charge, and converting the amplified charge into a voltage. Further, the reception unit 220 uses an Analog-to-Digital (A/D) converter 224 for digitalizing the value of the detected voltage and processing the value as data.

Further, since it is difficult to process a signal because the amount of the received signal corresponds to a very small value as described above, a method which has generally been used is the method of increasing the output voltage transmitted to the transmission electrode from the transmission unit 212 and increasing transmission energy, thereby increasing the amount of energy to be transferred to a reception electrode. In order to increase the voltage of a transmission signal, a power booster (charge pump or Direct Current (DC) converter (not shown) of the circuit is generally used.

The basic object of a reception circuit using the mutual cap method is to determine whether a touch is generated or not using difference between the basic capacitance components of a touch panel and capacitance components varied by the touch of a user, and to calculate the position at which the touch is generated by the user on each of the transmission electrode and the sensing electrode.

Here, when the capacitance of the capacitor C0 of FIG. 3 existing on a touch panel having a physical structure in which transmission electrodes and sensing electrodes overlap each other in order to sense capacitance, the transmission circuit 210 is operated using the transmission control signals 211 (S0, S1) of FIG. 3 having a rectangular wave-type voltage waveform 211 of FIG. 2 through the sensing electrode.

The capacitance of the capacitor C0 is defined as comprehensive capacitance which includes both the basic capacitance existing on the touch panel and the capacitance components generated when a user performs a touch action, and which is generated between a transmission electrode TX and a reception electrode RX. Here, at every period of the transmission signal, the flow of weak charge (current) is generated toward the reception unit side (RX of FIG. 3) due to the capacitance of the capacitor C0. Due to the weak flow of charge, the flow of charge cannot be directly converted to a voltage and then processed. Therefore, a transmission wave (rectangular wave) is transmitted at a plurality of periods, and the flow of charge received at each of the periods is converted to voltage and then the resulting voltage is accumulated using the charge integrator 222. Thereafter, when the accumulated voltage is quantized (digitized) using an Analog-to-Digital Converter (ADC) 224, a digital circuit recognizes whether a touch is generated by a user or not using the variation in the digitized values.

In the configurations of the circuits of FIGS. 2 and 3, a circuit used to faithfully sense the variation in the flow of the received charge, that is, the variation in current, and to convert the variation into voltage is called a charge integrator 222. The analog properties of such a charge integration circuit are the core of the capacitance sensing circuit.

When such a charge integrator is implemented according to the prior art, a general Operational Amplifier (OPAMP) integration circuit has been used as in the embodiment of the charge integrator 222. However, such an integration circuit is disadvantageous in that an insignificant current is transferred to a reception unit side because it is very difficult to match transmission impedance with reception impedance, and in that voltage cannot be accurately maintained after integration was performed because output voltage varies due to integration draft when charge is integrated using an OPAMP.

Further, as shown in FIG. 4 which illustrates operational voltages of the respective circuits of FIG. 3, integration Vint can be performed at only the rising edge 260 or falling edge 261 of each period of the square-wave-type transmission waveform TX of FIG. 4 in response to an integration control signal 241, so that the prior art is disadvantageous because a reception signal uses only half of energy compared to a transmission signal.

Further, the second prior art used to implement multi-touch includes circuits, such as the signal amplifier 212, the integrator 222, the A/D converter 224, and the power booster (not shown), as shown in FIGS. 2 and 3, thereby having the problems of inefficiency because expense increases, structurally very complex and elaborate circuits are implemented, and power consumption increases.

In particularly, a technology for designing the charge integration circuit and the signal amplifier of the capacitance sensing circuit components, which are used to sense the change in a reception signal and to determine whether touch is generated by a user, is incomplete because it has many points that need to be improved, and has limitations that are its being weak to the noise which flows into it from a display device which is close to a touch panel, or noise components, such as high-frequency signals which flow into it from the outside or electromagnetic disturbing elements, even when a touch is not generated. Therefore, it has been difficult to accurately sense a touch generated by a user.

### SUMMARY OF THE INVENTION

Accordingly, the present invention has been made keeping in mind the above problems occurring in the prior art, the present invention improves the problems of conventionally used capacitance sensing circuits when implementing a touch panel device using a mutual cap method which supports multi-touch, and further the present invention implements and provides a capacitance sensing circuit which supports multi-touch which can be easily manufactured using a semiconductor, has low power consumption, has high tolerance which is robust to noise flowing in from the outside, and has a rapid sensing speed.

Therefore, an object of the present invention is to provide a capacitance sensing circuit which can accurately maintain voltage after integration was performed on the variation in output voltage components, and can receive a reception signal which is stronger than a transmission signal.

In order to accomplish the above object, the present invention provides a multi-touch panel capacitance sensing circuit, including a touch panel having x-axis electrodes and y-axis electrodes; a transmission circuit unit for applying a transmission signal, having a predetermined period, to the x-axis electrodes in a time division manner; and a reception circuit unit for detecting a difference in capacitance components, generated between relevant x-axis electrode and y-axis electrode, based on the y-axis electrode when a touch is generated by the human body of a user; wherein the reception circuit unit includes a current mirror-based charge integration circuit, and detects whether a touch is generated by separately integrating the rising period and the falling period of a square-wave transmission signal applied from the transmission circuit unit and by detecting a difference in the capacitance components generated between the x-axis electrode and the y-axis electrode of the touch panel.

Further, the reception circuit unit may include a pair of integration switch units which are respectively turned on and turned off in such a way that a reverse-phase signal receives an L value or an H value in response to a rising edge control signal or a falling edge control signal; first and second N-channel Metal-Oxide-Semiconductor Field-Effect Transistors (NMOSs) which are in a current mirror relationship, and in which a voltage, which flows in order to charge the touch panel with capacitance, forms a same current received from the turned-on integration switch unit; first and second P-channel Metal-Oxide-Semiconductor Field-Effect Transistors (PMOSs) which are in a current mirror relationship, and in which gates are connected to the drain of the second NMOS in order to provide a reference current; and a capacitor in which each of a rising edge and a falling edge is repeatedly performed, transferred charge components are integrated using the capacitance of the touch panel and then repeatedly charged with, and output voltage is generated based on the charge.

Further, the transmission circuit unit may include a plurality of switch units turned on and turned off in response to control signals used to control the rising edge and the falling edge, respectively; and a plurality of inverters used to turn on and turn off the switch units of the reception circuit unit by providing reverse-phase signals.

Further, the transmission circuit unit may include a plurality of switch units turned on and turned off in response to control signals used to control the rising edge and the falling edge, respectively; and a plurality buffers used to turn on and turn off the switch units of the reception circuit unit by providing in-phase signals.

Further, the reception circuit unit may provide functions of arranging and connecting a plurality of transistors which are in a current mirror relationship with the first PMOS, which can be switched, and which have gates whose areas are different from each other; connecting switch units to the respective drain terminals of the plurality of transistors; and controlling integrated current.

Further, the reception circuit unit may provide functions of maximizing the Signal to Noise Ratio (SNR) of a reception signal in such a way as to control receiving basic mirroring current by controlling the areas of the gates of the first PMOS and the first NMOS, the drain of the first PMOS and the gate of the first NMOS being connected to a same node, and, at the same time, in such a way as to control a signal charge received from the transmission signal by controlling the impedance of a reception terminal for the transmission signal.

Further, the capacitor may include a plurality of capacitors configured to have respective capacitances which are different from each other; and a plurality of switches used to selectively turn on and turn off the plurality of capacitors and connected to the respective capacitors.

Further, the reception circuit unit may include a first transistor which is configured to generate a reference current; a plurality of transistors which are in a current mirror relationship with the first transistor and are arranged and connected to the first transistor; a plurality switch units which are connected to the respective drain terminals of the plurality of transistors in order to form a precise discharging current by performing switching; and transistors which are in a current mirror relationship, and are provided at the terminal of the precise discharging current output from the plurality of transistors in order to generate a final precise discharging current used to discharge a specific amount of an integrated voltage.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a self cap-based capacitance measurement circuit according to an embodiment of the prior art;

FIG. 2 is a view illustrating a mutual cap-based capacitance measurement circuit according to another embodiment of the prior art;

FIG. 3 is the detailed circuit diagram of FIG. 2 according to the prior art;

FIG. 4 is a view illustrating the operational waveforms of the mutual cap-based capacitance measurement circuit of FIG. 2;

FIG. 5 is a view illustrating a multi-touch panel capacitance sensing circuit according to the present invention;

FIG. 6 is a view illustrating the operational status of a circuit at the rising edge of the transmission signal of FIG. 5;

FIG. 7 is a view illustrating the operational status of a circuit at the falling edge of the transmission signal of FIG. 5;

FIG. 8 is a view illustrating a multi-touch panel capacitance sensing circuit according to another embodiment of the present invention;

FIG. 9 is a view illustrating the integrated current adjustment circuit of FIG. 8 in detail;

FIG. 10 is a view illustrating the integrated capacitance adjustment circuit of FIG. 8 in detail;

FIG. 11 is a view illustrating the integrated attenuation current adjustment circuit of FIG. 8 in detail; and

FIG. 12 is a view illustrating the waveforms of the capacitance sensing circuit according to the present invention.

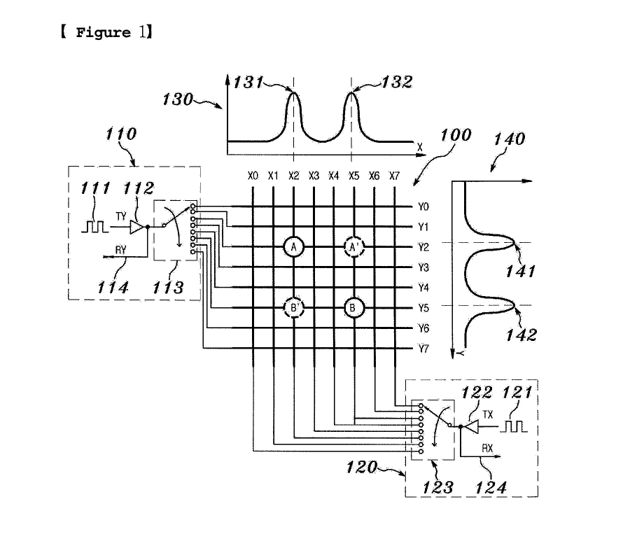

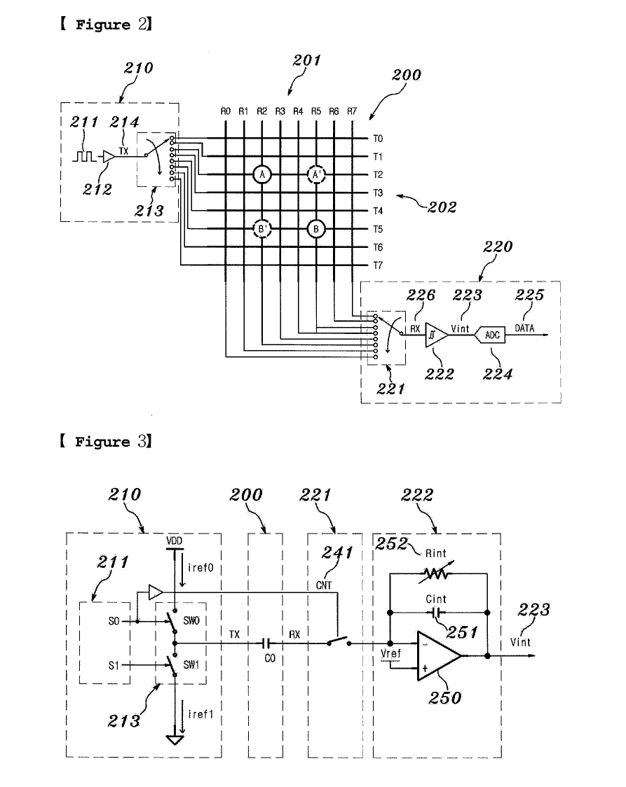

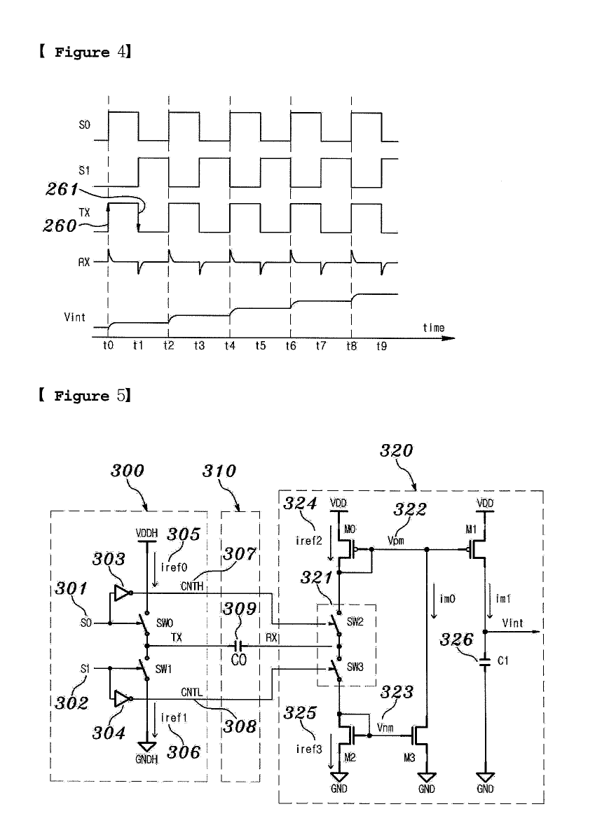

### DESCRIPTION OF THE PREFERRED EMBODIMENTS

Reference now should be made to the drawings, in which the same reference numerals are used throughout the different drawings to designate the same or similar components.

Hereinafter the embodiments of a multi-touch panel capacitance sensing circuit according to the present invention will be described in detail with reference to the attached drawings.

The multi-touch panel capacitance sensing circuit according to the present invention includes a touch panel having x-axis electrodes and y-axis electrodes, a transmission circuit unit 300 for applying a transmission signal, having a predetermined period, to the x-axis electrodes in a time division manner, and a reception circuit unit for detecting difference in capacitance components generated between electrodes 310, configured with an x-axis electrode and an y-axis electrode, based on the y-axis electrode. The reception circuit unit includes a current mirror-based charge integration circuit, and detects whether a touch is generated by separately integrating the rising period and falling period of a square-wave transmission signal applied from the transmission circuit unit and by detecting the difference in the capacitance components generated between the x-axis electrode and the y-axis electrode of the touch panel.

According to the principal gist of the multi-touch panel capacitance sensing circuit according to the present invention, the transmission circuit unit 300 for providing a transmission signal is the same as that of the prior art. However, with regard to the reception circuit unit 320 for receiving a reception signal and detecting whether a touch is generated, a current mirror-based charge integration circuit is used instead of an Operational Amplifier (OPAMP)-based integration circuit 222 in order to perform charge integration.

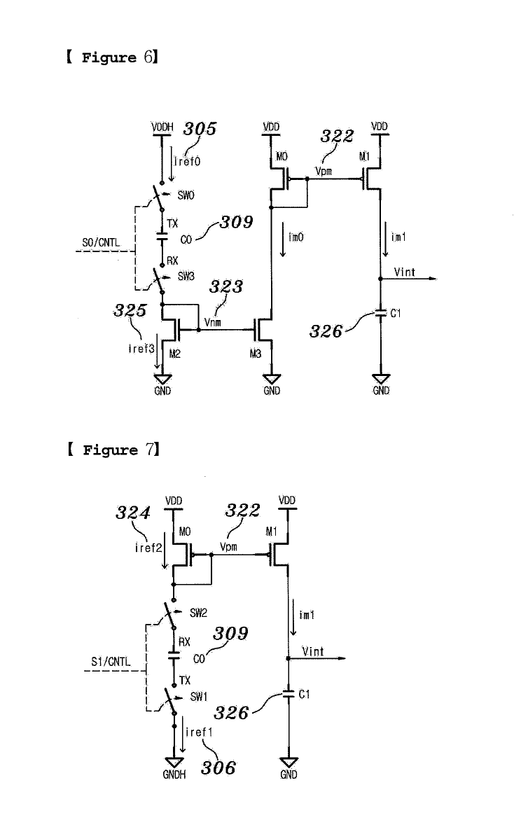

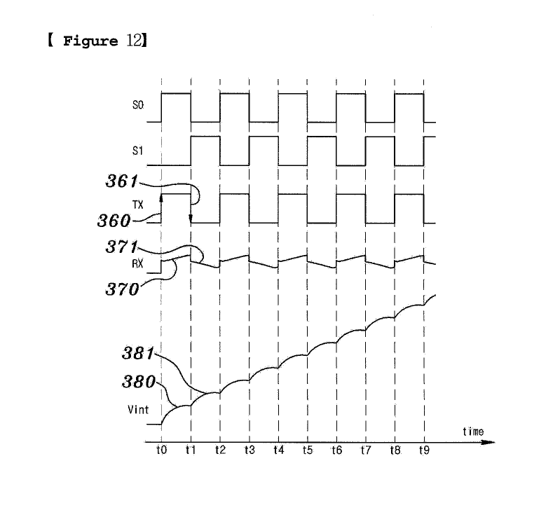

FIG. 5 is a view illustrating a multi-touch panel capacitance sensing circuit according to the present invention. At every period of a square-wave-type transmission waveform TX as shown in FIG. 12 which illustrates the operational voltage of each of the circuit components of FIG. 5, operation is performed using the circuit components shown in FIG. 6 at the rising edge 360 of the TX signal and operation is performed using the circuit components shown in FIG. 7 at the falling edge 361 in response to an integration control signal 307 or 308.

Therefore, charge, received at both the rising edge and the falling edge of the transmission signal TX, can be integrated in the present invention, so that there is the advantage of integrating double charge energy compared to the prior art.

A current mirror-based charge integration circuit according to the present invention operates in the following two modes in response to the control signals 307 and 308 of the reception switch, which are synchronized with square-wave-type switch control signals 301 and 302 used as the control signals of the transmission circuit, in reverse phase.

The operation at the rising edge will be described first.

FIG. 6 is a view illustrating the configuration of a circuit at the rising edge of the transmission signal of FIG. 5. That is, FIG. 6 illustrates only the circuits of the circuit components of FIG. 5, which operate at the time from the rising edge to immediately before the falling edge of one period of the TX signal, that is, the time from t0 to t1 in the time axis of the voltage waveform of FIG. 12. During the corresponding time period, the value of the control signal 301 (S0 of FIG. 12) of a transmitter, which is used to control the rising edge, is “H”, so that SW0 is turned on, and then the signal 301 is changed into a reverse-phase signal 307 by an inverter 303, so that the value thereof is “L”, thereby turning off SW2.

Meanwhile, the value of the control signal 302 (S1 of FIG. 12) used to control the falling edge of the transmitter is “L”, with the result that SW1 is turned off, so that the signal 302 is changed into a reverse-phase signal by an inverter 304 and the value thereof is “H”, thereby turning on SW3. Here, if SW1 and SW2 are turned off and the basic capacitance of the capacitor C0 309 of the capacitance sensor 200 is sufficiently discharged to 0V at the initial stage in FIG. 5, current, which corresponds to iref0 305 and is used to charge the initial capacitor C0 309, flows from VDDH through a TX signal line because of the turned-on switches SW0 and SW3.

The size of the current iref0 305 is determined based on the capacitance of the capacitor C0 309. Therefore, when a touch is generated by a user, the current iref0 305 varies due to the capacitance of a third capacitor (not shown), which is formed because a human body comes into contact with a sensor surface. Here, the waveform of a voltage measured by RX node is the same as the waveform of RX 370 of FIG. 12.

The current, which flows in order to charge the touch panel capacitor C0 309, flows into GND through an N-channel Metal-Oxide-Semiconductor Field-Effect Transistor (NMOS) M2 (first NMOS), in which a gate is connected to a drain, through SW3, the current corresponding to iref3 325. Here, the value of iref0 is the same as the value of the iref3 based on the law governing a basic engineering circuit.

This is expressed as the following Equation.

iref0=iref3 (1)

where if the area of the gate of an NMOS transistor M3 (second NMOS), which shares the gate with the M2, is the same as that of the M2, the value of current im0, which flows through the M3, is the same as the value of the iref3 based on the current mirror law.

iref3=im1 (2)

On the same principle, current, which flows through a P-channel MOSFET (PMOS) transistor M0 (first PMOS), is im0 based on the law governing a basic engineering circuit. Further, if the area of the gate of the PMOS transistor M1 (second PMOS) is the same as that of the M0, the value of current im1, which flows through the M1, is the same as the value of the im0 based on the current mirror law.

im0=im1 (3)

Therefore, the relational expression of all current which may be expressed in the circuit of FIG. 6 is expressed as the following Equation 4.

iref0=iref3=im0=im1 (4)

Here, if a capacitor C1 326 for storing the flow of receiving charge, that is, the current, is initially discharged and then current im1 flows for a while in order to charge C1 326, voltage Vint is generated based on the charge which will be accumulated in C1 326 based on the current mirror law, and the waveform of the voltage is Vint 380 of FIG. 12.

Next, the operation at the falling edge will be described.

FIG. 7 is a view illustrating the configuration of a circuit at the falling edge of the transmission signal of FIG. 5. Like the description in FIG. 6, FIG. 7 briefly illustrates only the circuits of the circuit components of FIG. 5, which operate at the time of one period of the TX signal from the falling edge to immediately before the rising edge, that is, the time from t1 to t2 in the time axis of the voltage waveforms of FIG. 12. In that time period, the value of the control signal 302 (S1 of FIG. 12), used to control the falling edge of the transmission circuit unit, is “H”, so that SW1 is turned on. Further, the signal 302 is changed into a reverse-phase signal 308 using the inverter 304, and the value of the signal 302 is “L”, so that SW3 is turned off.

Here, the drain and the gate node Vnm 323 of the NMOS transistor M2 is open because of the turned-off switch SW3, so that the value of the current iref3 which flows through the NMOS transistor M2 is 0, and the value of the current which flows through the transistor M3 is 0 based on the current mirror law. Therefore, the value of the current which flows through M2 and M3 is 0 in FIG. 5, so that M2 and M3 are not operating circuit elements, thereby being excluded from the circuit analysis as in FIG. 7.

Meanwhile, the value of the control signal 301 (50 of FIG. 12) of the transmission circuit unit, used to control the rising edge, is “L”, so that SW0 is turned off. Further, the signal 301 is changed into a reverse-phase signal by the inverter 303 and the value of the signal 301 is “H”, so that SW1 is turned on.

Here, if SW0 and SW3 are turned off and the basic capacitor C0 309 of the capacitance sensor 200 is sufficiently charged at that time in FIG. 5, current, which is used to discharge the initial capacitor C0 309, flows from the TX node to GNDH because of the turned-on switches SW1 and SW2, the current corresponding to iref1 306. The amount of current iref1 306 is determined based on the capacitance of the capacitor C0 309. Therefore, when a touch is generated by a user, the amount of current iref1 306 changes because of the capacitance of a third capacitor (not shown) which is formed because a human body has come into contact with a sensor surface. Here, the waveform of voltage measured by the RX node of FIG. 7 is the same as the waveform of the RX 371 of FIG. 12.

The current, which flows in order to discharge the capacitor C0 309, flows from VDDD through a PMOS transistor M0, in which a gate is connected to a drain, using SW2, the current corresponding to iref2 324. Here, the value of the current iref1 is the same as the value of the current iref2 based on the law governing a basic engineering circuit. This is expressed in the following Equation.

iref1=iref2 (5)

where if the area of the gate of the PMOS transistor M1, which shares the gate with M0, is the same as that of M0, the value of current im1, which flows through M1, is the same as the value of iref2 based on the current mirror law.

iref2=im1 (6)

Therefore, the relational expression of all current which may be expressed using the circuit of FIG. 7 is expressed as the following Equation 7.

iref1=iref2=im1 (7)

Here, if the capacitor C1 326 for storing the flow of receiving charge, that is, the current, is partially charged in the period of t0 to t1 of FIG. 12 and then current im1 flows for a while in order to charge C1 326 at the period of t1 to t2, voltage Vint increases depending on charge accumulated in C1 326 based on the law governing a basic engineering circuit, and the waveform of the voltage is the same as Vint 381 of FIG. 12.

When each of the rising edge and falling edge of the TX waveform of FIG. 12 is repeatedly performed based on the above-described principle, the circuit components of each of FIGS. 6 and 7 are sequentially operated, with the result that the transferred charge components are integrated using the capacitor C0 309 of a system and then the integration capacitor C1 326 is repeatedly charged, so that charge is changed into the voltage Vint and then the voltage is accumulated using the integration capacitor C1 326.

Further, the capacitance of C0 309 varies (not shown) according to a case where a touch is generated by a human body and a case where a touch is not generated based on the basic capacitance which exists between the transmission electrode (x axis) and the reception electrode (y axis).

Therefore, since the value of the voltage Vint, which is accumulated in C1 326, differs according to the case where a touch is generated by a human body and the case where a touch is not generate because of the variation in the capacitance of C0 309, the accumulated voltage Vint may be used to accurately determine whether a touch is generated by a human body using an ADC.

Here, in the circuit of FIG. 5, the reception signal RX, which is received through C0 309 at the rising edge and falling edge of the transmission signal TX, may be connected to current load which enables some of current to be conducted using MOS transistor-based diode voltage and current property curve (I-V curve, not shown) toward GND and VDD which correspond to the sources of the respective NMOS transistor M2 and PMOS transistor M0, which are connected so as to perform an MOS diode-type operation whose gate terminal is connected to the drain terminal thereof. Therefore, when viewed from the TX node, the impedance of terminals may be lowered. With the lowered impedance, a larger amount of charge may be transmitted from the output signal TX to the RX node, thereby increasing the flow of current between TX and RX.

The increased current is used as a transmission signal between TX and RX. When capacitance is measured using the circuit of FIG. 5, a phenomenon occurs in which the strength of signal relatively increases as much as the increased signal while noise which flowing in from the outside remains unchanged.

Therefore, the capacitance sensing circuit according to the present invention has high capacitance sensing ability because the Signal to Noise Ratio (SNR) increases while the circuit is operating in order to sense capacitance.

Further, if necessary, the load (the amount of the flow of current) of the reception signal to the transmission signal can be controlled by controlling the areas of the gates of the transistors M0 and M2 based on the above-described principle, with the result that the impedance of the signal TX can be matched with the impedance of the signal RX, so that the transmission signal can be more faithfully received based on the maximum power transfer law, thereby additionally maximizing the SNR.

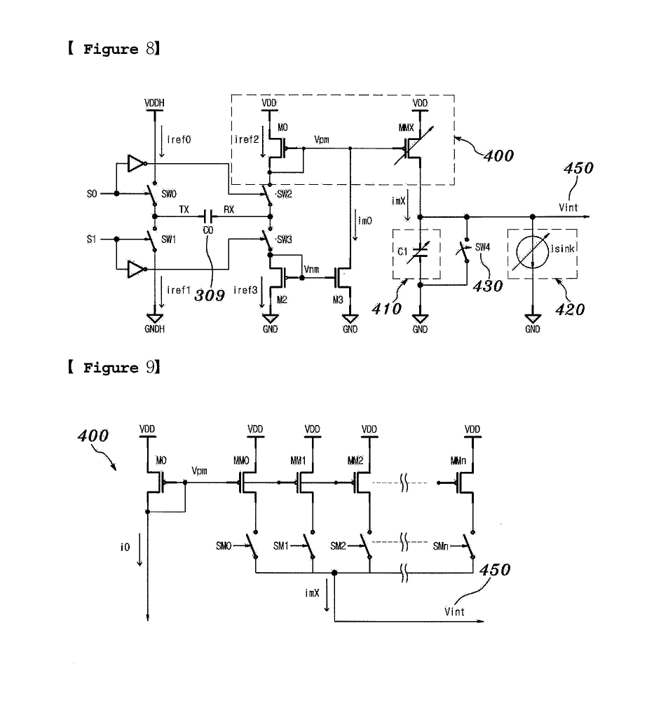

FIG. 8 is a view illustrating a multi-touch panel capacitance sensing circuit according to another embodiment of the present invention. The capacitance sensing circuit that is shown corresponds to a circuit in which performance is improved compared to the above-described circuit of FIG. 5. A current mirror 400 includes an array of a transistor M0 which provides reference current iref2 or im0, and a transistor MMX which has a current mirror relationship with the transistor M0 and can be switched. Therefore, the actually integrated current of the reference current iref2 or im0, which is initially received in order to sense capacitance, can be controlled in a variety of different manners.

FIG. 9 is a view illustrating the integrated current adjustment circuit of FIG. 8 in detail. According to the current mirror law, it is assumed that the gate area of the transistor M0 is 1 and the gate areas of transistors MM0 to MM7, which are in the mirror relationship with the transistor M0, are 0.125, 0.25, 0.5, 1.0, 2.0, 4.0, 8.0, and 16.0, respectively. When control is performed in such a way that the transistors MM0 to MM7 are provide with switches SM0 to SM7 which are connected to the respective drains of the transistors MM0 to MM7. Therefore, the reference current i0 which flows through M0 of FIG. 9 is controlled in the units of 0.125 times, so that integrated current imX, which is amplified from a minimum of 0, 0.125, and 0.25 times of the reference current i0, that is, decreased integrated current compared to the reference current, and to a maximum of 31.875 times, may flow through Vint node 450.

Therefore, reception charge-based charging current may be variously set to a capacitor C1 401 for accumulating current, with the result that a proper number of reception periods of the transmission signal may be easily set, so that accurate integration period and the reception time, which are required by the touch panel, may be easily set and the capacitance can be accurately accumulated and measured.

Examples of the attenuation and amplification of integrated current using current mirror are shown in Table 1.

TABLE 1

| | | | | | | | | | Current |
|---|---|---|---|---|---|---|---|---|---|
| | | | | | | | | | of |
| | | | | | | | | | imX |
| | | | | | | | | | com- |
| | | | | | | | | | pared |
| | | | | | | | | | to i0 |
| | | | | | | | | | (Mul- |
| No | SM7 | SM6 | SM5 | SM4 | SM3 | SM2 | SM1 | SM0 | tiple) |
| 0 | 0 | 0 | 0 | 0 | 0 | 0 | 0 | 0 | 0.000 |
| 1 | 0 | 0 | 0 | 0 | 0 | 0 | 0 | 1 | 0.125 |
| 2 | 0 | 0 | 0 | 0 | 0 | 0 | 1 | 0 | 0.250 |
| 3 | 0 | 0 | 0 | 0 | 0 | 0 | 1 | 1 | 0.375 |
| 252 | 1 | 1 | 1 | 1 | 1 | 1 | 0 | 0 | 31.500 |
| 253 | 1 | 1 | 1 | 1 | 1 | 1 | 0 | 1 | 31.625 |
| 254 | 1 | 1 | 1 | 1 | 1 | 1 | 1 | 0 | 31.750 |
| 255 | 1 | 1 | 1 | 1 | 1 | 1 | 1 | 1 | 31.875 |

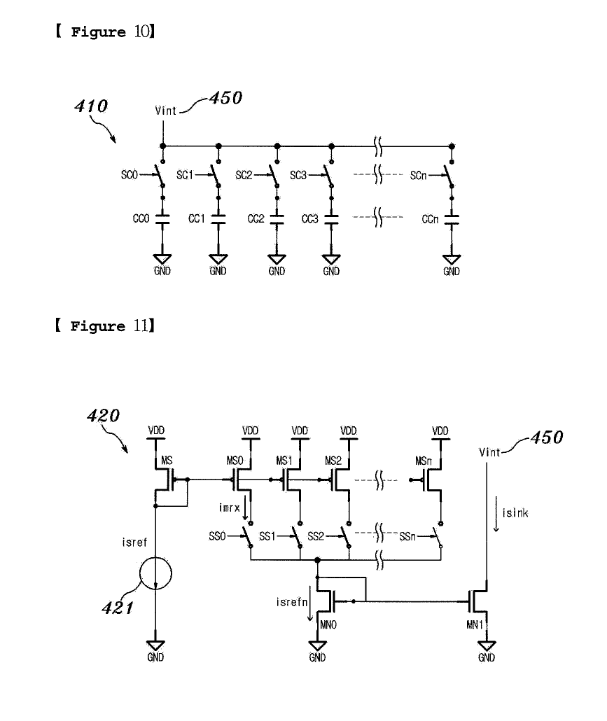

Further, in order to improve the further performance of FIG. 8, the integration capacitor C1 410 may be implemented using the circuit of FIG. 10. FIG. 10 is a view illustrating the integrated capacitance adjustment circuit of FIG. 8 in detail. Since the capacitance of the sensor capacitor C0 309 for converting the transmission signal TX into the reception signal RX corresponds to the unique capacitance of the touch screen panel, the value thereof variously varies according to the size and material of the touch panel and the structure of a transmission electrode and a reception electrode.

Therefore, even in the case of the same value of the transmission signal TX, the capacitance of the sensor capacitor C0 309 may vary, so that the value of the reception signal RX varies as well. Therefore, the capacitance of the integration capacitor C1 410 should vary such that integration is performed in the specific range of stable values for the desired period of a transmission signal and voltage is generated.

Generally, when the capacitance of C0 is less and the charge of the reception signal is less, the capacitance of C1 should be less, and, when the capacitance of C0 is high and the charge of the reception signal is great, the capacitance of C1 should be great, thereby obtaining an integration signal of the desired voltage for the period of a stable TX signal. Therefore, capacitors shown in FIG. 10 should be provided and control should be performed if necessary. Further, when it is assumed that the unit of CCO is 1 and the capacitance of respective capacitors CCO to CCn, shown in FIG. 10, are set in multiples, such as 2, 4, 8, 16 and 32, the value of C1 corresponding to the inter times of the value of CCO may be set by turning on or turning off selection switches SCO to SCn.

FIG. 11 is a view illustrating the integrated attenuation current adjustment circuit of FIG. 8 in detail.

FIG. 11 shows the precise discharging current source 420 of FIG. 8 in which the performance is improved.

When the capacitance of C1 is sufficiently charged before the difference in integrated current, attributable to touch generated by a user in FIGS. 9 and 10, is obtained, there may be a case where the voltage Vint generated based on the integrated current is greater than the threshold, so that the integrated voltage may not increase even though receiving charge increases. In this case, if the predetermined amount of integrated current is previously discharged in such a way that current which is less than the integrated current is regularly supplied between the integrated charge node and GND, it is possible to prevent the case where the desired value cannot be measured because integrated voltage reaches the threshold before the desired specific time.

To describe the precise discharging current source in detail, precise discharging current isrefn is formed in such a way that a reference current source isref 421 is generated, transistors MSO to MSn, which are in the current mirror relationship with a PMOS transistor MS, are allocated, and the transistors MSO to MSn are switched on or switched off using SSO to SSn, and then final precise discharging current isink is generated using a current mirror configured with a transistor MN0 and a transistor MN1. The operational principle is the same as that of the current mirror of FIG. 9.

The present invention configured as described may provide a capacitance sensing circuit which performs integration in both rising period and falling period of a transmission signal, thereby having the advantages of accurately maintaining voltage of output voltage variation components after integration was performed, and receiving a reception signal which is stronger than a transmission signal.

Further, the present invention has the advantages of supporting multi-touch which can be easily manufactured using a semiconductor, has low power consumption, has high tolerance which is robust to noise flowing in from the outside, and has a rapid sensing speed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A multi-touch panel capacitance sensing circuit, comprising:
a touch panel having transmission electrodes and reception electrodes;
a transmission circuit unit for applying a transmission signal, having a predetermined period, to the transmission electrodes in a time division manner; and
a reception circuit unit for detecting a difference in capacitance components, generated between relevant transmission electrode and reception electrode, based on the reception electrode when a touch is generated by a human body of a user;
wherein the reception circuit unit includes a current mirror-based charge integration circuit, and detects whether a touch is generated by separately integrating a rising period and a falling period of a square-wave transmission signal applied from the transmission circuit unit and by detecting a difference in the capacitance components generated between the transmission electrode and the reception electrode of the touch panel.

2. The multi-touch panel capacitance sensing circuit as set forth in claim 1, wherein the reception circuit unit comprises:
a pair of integration switch units which are respectively turned on and turned off in such a way that a reverse-phase signal receives an L value or an H value in response to a rising edge control signal or a falling edge control signal;
first and second N-channel Metal-Oxide-Semiconductor Field-Effect Transistors (NMOSs) which are in a current mirror relationship, and in which a voltage, which flows in order to charge the touch panel with capacitance, forms a same current received from the turned-on integration switch unit;
first and second P-channel Metal-Oxide-Semiconductor Field-Effect Transistors (PMOSs) which are in a current mirror relationship, and in which gates are connected to a drain of the second NMOS in order to provide a reference current; and
a capacitor in which each of a rising edge and a falling edge is repeatedly performed, transferred charge components are integrated using the capacitance of the touch panel and then repeatedly charged with, and output voltage is generated based on the charge.

3. The multi-touch panel capacitance sensing circuit as set forth in claim 2, wherein the transmission circuit unit comprises:
a plurality of switch units turned on and turned off in response to control signals used to control the rising edge and the falling edge, respectively; and
a plurality of inverters used to turn on and turn off the switch units of the reception circuit unit by providing reverse-phase signals.

4. The multi-touch panel capacitance sensing circuit as set forth in claim 2, wherein the transmission circuit unit comprises:
a plurality of switch units turned on and turned off in response to control signals used to control the rising edge and the falling edge, respectively; and
a plurality buffers used to turn on and turn off the switch units of the reception circuit unit by providing in-phase signals.

5. The multi-touch panel capacitance sensing circuit as set forth in claim 2, wherein the reception circuit unit provides functions of arranging and connecting a plurality of transistors which are in a current mirror relationship with the first PMOS, which can be switched, and which have gates whose areas are different from each other; connecting switch units to respective drain terminals of the plurality of transistors; and controlling integrated current.

6. The multi-touch panel capacitance sensing circuit as set forth in claim 2, wherein the reception circuit unit provides functions of maximizing a Signal to Noise Ratio (SNR) of a reception signal in such a way as to control receiving basic mirroring current by controlling areas of gates of the first PMOS and the first NMOS, the drain of the first PMOS and the gate of the first NMOS being connected to a same node, and, at the same time, in such a way as to control a signal charge received from the transmission signal by controlling impedance of a reception terminal for the transmission signal.

7. The multi-touch panel capacitance sensing circuit as set forth in claim 2, wherein the capacitor comprises:
a plurality of capacitors configured to have respective capacitances which are different from each other; and
a plurality of switches used to selectively turn on and turn off the plurality of capacitors and connected to the respective capacitors.

8. The multi-touch panel capacitance sensing circuit as set forth in claim 2, wherein the reception circuit unit comprises:
a first transistor which is configured to generate a reference current;
a plurality of transistors which are in a current mirror relationship with the first transistor and are arranged and connected to the first transistor;
a plurality switch units which are connected to respective drain terminals of the plurality of transistors in order to form a precise discharging current by performing switching; and
transistors which are in a current mirror relationship, and are provided at a terminal of the precise discharging current output from the plurality of transistors in order to generate a final precise discharging current used to discharge a specific amount of an integrated voltage.
